(19) United States
(12) Patent Application Publication
(10) Pub. No.: US 2025/0200188 A1
(43) Pub. Date: Jun. 19, 2025

(54) METHOD AND DEVICE FOR CHECKING VULNERABILITY IN ELECTRONIC DEVICE

(71) Applicant: NORMA Inc., Seoul (KR)

(72) Inventors: Hyunchul Jung, Seoul (KR); Chang Nyoung Song, Seoul (KR)

(21) Appl. No.: 18/391,673

(22) Filed: Dec. 21, 2023

(30) Foreign Application Priority Data
Dec. 15, 2023 (KR) 10-2023-0183173

(51) Int. Cl. G06F 21/57

(52) U.S. Cl. CPC G06F 21/577; G06F 2221/034

(57) ABSTRACT

A method of checking a vulnerability of an electronic device, performed by a vulnerability checking device, includes classifying the electronic device by using at least two of a plurality of device classification methods in a preconfigured execution order; and checking whether the vulnerability is present in the electronic device according to a result of the classification of the electronic device, wherein the plurality of device classification methods may include a first method of using a MAC address, a second method of using a SNMP (Simple Network Management Protocol), a third method of using a Universal Plug and Play (UPnP), a fourth method of using a Bonjour protocol, a fifth method of using a web page provided by the electronic device, and a sixth method of using a NetBIOS.

### CROSS-REFERENCE TO RELATED APPLICATION

This application claims priority to and the benefit of Korean Patent Application No. 10-2023-0183173, filed on Dec. 15, 2023, the disclosure of which is incorporated herein by reference in its entirety.

### BACKGROUND

### Technical Field

The present invention relates to a method and a device for checking a vulnerability in an electronic device.

### Background Art

The Internet has been used as a space where humans can share information as producers/consumers of information. In the future, it is predicted that the era of IoT will come where even objects around us, such as home appliances and sensors, are connected to the network so that environmental information around objects and information of objects themselves can be shared. As the concept of controlling and managing objects spread through the Internet, a number of products appeared. With the advent of the IoT era, it is expected that various communications between objects and objects will be made, and devices supporting IoT, such as sensors and home appliances, can be accessed through a smartphone, which is a type of device supporting IoT.

As described above, in the IoT era, the dependence on the Internet and the network is expected to gradually increase, and as the dependence increases, there is a need to protect the IoT device from hacking viruses and operate it safely. In order to protect IoT devices from hacking viruses, it is best to identify problems through vulnerability analysis of IoT devices and prepare for damage in advance.

However, a plurality of electronic devices are connected to each other to configure one IoT environment, and it is not efficient to check the specifications of the electronic devices for each of the plurality of electronic devices and check the vulnerability according to the specifications.

### SUMMARY

### Technical Problem

The present invention has been made in an effort to provide a method for classifying electronic devices by sequentially performing at least two of a plurality of device classification methods, and checking a vulnerability of the classified electronic devices.

However, the problems to be solved by the present invention are not limited to those mentioned above, and other problems to be solved which are not mentioned will be clearly understood by those skilled in the art from the following description.

### Technical Solution

According to an aspect of an exemplary embodiment, there is provided a method of checking a vulnerability of an electronic device. The method, performed by a vulnerability checking device, may include: classifying the electronic device using at least two of a plurality of device classification methods in a preconfigured execution order; and checking whether the vulnerability is present in the electronic device according to a result of the classifying the electronic device. The plurality of device classification methods may include: a first method of using a MAC address; a second method of using a Simple Network Management Protocol (SNMP); a third method of using a Universal Plug and Play (UPnP); a fourth method of using a Bonjour protocol; a fifth method of using a web page provided by the electronic device; and a sixth method of using NetBIOS.

The execution order may be an ascending order of at least two of the first to sixth methods.

The classifying the electronic device, when using the first method, may include: collecting the MAC address of the electronic device; and identifying a manufacturer and a product name of the electronic device by comparing Organizationally Unique Identifier (OUI) and Network Interface Controller (NIC) Specific information included in the MAC address with a plurality of QUI and a plurality of NIC Specific information stored in a MAC address DB included in the vulnerability checking device.

The classifying the electronic device, when using the second method, the third method, or the fourth method, may include: transmitting a request message using a protocol corresponding to a method used for classifying the electronic device among the SNMP, the UPnP, and the Bonjour protocol to the electronic device; receiving a response message from the electronic device in response to the request message; and identifying a manufacturer and a product name of the electronic device by comparing a character string in the response message with an electronic device DB included in the vulnerability checking device.

The classifying the electronic device, when using the fifth method, may include: accessing the web page provided by the electronic device by using web page addresses stored in a web page address DB included in the vulnerability checking device; obtaining a web page code by crawling the web page; and identifying a manufacturer and a product name of the electronic device by comparing a character string in the web page code with an electronic device DB included in the vulnerability checking device.

The classifying the electronic device, when using the sixth method, may include: transmitting a request message using a NetBIOS Name Service (NBNS) provided by the NetBIOS to the electronic device; receiving a response message from the electronic device in response to the request message; and identifying a product name of the electronic device by comparing a character string in the response message with an electronic device DB included in the vulnerability checking device.

The identifying the product name of the electronic device may include: identifying a manufacturer of the electronic device by using at least one of the first to fifth methods; and identifying the product name of the electronic device by comparing the character string in the response message with product names of the identified manufacturer among a plurality of product names stored in the electronic device DB.

The method of checking the vulnerability of the electronic device may further include: storing the response message or a web page code in an analysis DB included in the vulnerability checking device when the character string does not include a manufacturer or the product name stored in the electronic device DB; and updating the manufacturer and the product name of the electronic device in the electronic device DB when the electronic device is completely classified by using a specific manual classification method.

the checking whether the vulnerability is present in the electronic device may include: loading information about the vulnerability of the electronic device from a vulnerability DB included in the vulnerability checking device; checking whether the vulnerability is actually present in the electronic device by using the information about the vulnerability; and transmitting a result of the checking to the electronic device.

According to another aspect of an exemplary embodiment, there is provided a device for checking a vulnerability of an electronic device, the device may include: a memory storing instructions for checking a vulnerability of an electronic device; and a processor controlling the memory. The processor classifies electronic device using at least two of a plurality of device classification methods in a preconfigured execution order, and checks whether the vulnerability is present in the electronic device according to a result of the classifying the electronic device. The plurality of device classification methods may include: a first method of using a MAC address; a second method of using a SNMP (Simple Network Management Protocol); a third method of using a Universal Plug and Play (UPnP); a fourth method of using a Bonjour protocol; a fifth method of using a web page provided by the electronic device; and a sixth method of using NetBIOS.

### BRIEF DESCRIPTION OF DRAWINGS

FIG. 1 is a block diagram illustrating a vulnerability checking device according to an embodiment.

FIG. 2 is a block diagram conceptually illustrating a function of a vulnerability checking program according to an embodiment.

FIG. 3 is an example of a MAC address.

FIG. 4 illustrates an example of classifying electronic devices by using a second method according to an embodiment.

FIG. 5 illustrates an example of classifying electronic devices by using a third method according to an embodiment.

FIG. 6 illustrates an example of classifying electronic devices by using a fourth method according to an embodiment.

FIG. 7 illustrates an example of classifying electronic devices by using a fifth method according to an embodiment.

FIG. 8 illustrates an example of classifying electronic devices by using a sixth method according to an embodiment.

FIG. 9 is a flowchart illustrating a method of classifying an electronic device and checking a vulnerability of the electronic device by a vulnerability checking device according to an embodiment.

FIG. 10 is a block diagram of a computing system according to an example embodiment.

### DETAILED DESCRIPTION

Hereinafter, embodiments of the present invention will be described in detail with reference to the accompanying drawings so that those skilled in the art to which the present invention pertains can easily practice the present invention. However, the present invention may be implemented in various different forms and is not limited to the examples described herein. In describing the operation principle of the exemplary embodiment of the present invention in detail, when it is determined that a detailed description of a related known function or feature may unnecessarily obscure the gist of the present invention, the detailed description thereof will be omitted.

In addition, the same reference numerals are used for parts performing similar functions and operations throughout the drawings. Throughout the specification, when a specific portion is connected to another portion, this includes not only a case where the specific portion is directly connected but also a case where the specific portion is indirectly connected with another element interposed therebetween. In addition, inclusion of a specific component means that other components may be further included, rather than excluding other components unless specifically stated otherwise.

Furthermore, when a certain part “includes” a certain element in the entire specification, this means that other elements may be further included, rather than excluding other elements, unless specifically stated otherwise.

The terms “first”, “second”, etc. may be used to describe various elements, but such elements should not be limited by the corresponding terms. That is, the terms are used only for the purpose of distinguishing one component from another component. For example, a first element could be termed a second element, and similarly, a second element could be termed a first element, without departing from the scope of the present invention. The term “and/or” includes a combination of a plurality of related described items or any of a plurality of related described items.

In addition, the terms used in the present invention are selected from general terms that are currently widely used in consideration of the functions in the present invention, but may vary depending on the intention or precedent of a person skilled in the art, the appearance of a new technology, and the like. Further, in a specific case, terms arbitrarily selected by the applicant may be used, and in this case, the meaning thereof will be described in detail in the description of the corresponding invention. Therefore, the terms used in the present invention should be defined based on the meanings of the terms and the overall contents of the present invention, not just the names of the terms.

Hereinafter, embodiments will be described in detail with reference to the drawings.

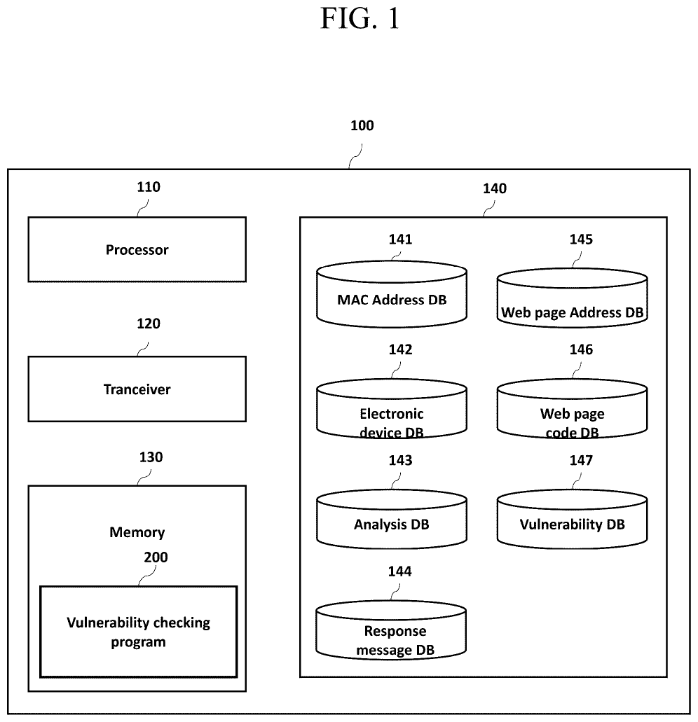

FIG. 1 is a block diagram illustrating a vulnerability checking device according to an embodiment.

Referring to FIG. 1, the vulnerability checking device 100 is for classifying electronic devices and checking the vulnerability of the classified electronic devices and may include a processor 110, a transceiver 120, a memory 130, and a database (DB) unit 140.

The processor 110 may control the overall operation of the vulnerability checking device 100.

The processor 110 may transmit a preconfigured request message to the electronic device by using the transceiver 120 and receive a response message in response to the transmitted request message.

According to an embodiment, the electronic device is a device capable of wired and/or wireless communication, and may be an Internet of Things (IoT) device.

In addition, the processor 110 may transmit a proof of concept (POC) code for checking the vulnerability of the electronic device to the classified electronic device using the transceiver 120.

The memory 130 may store the vulnerability checking program 200 and information (e.g., device-specific identification information, device-specific vulnerability information, etc.) necessary for execution of the vulnerability checking program 200.

In this specification, the vulnerability checking program 200 may refer to software including instructions programmed to classify electronic devices using at least two device classification methods and check the vulnerability of the classified electronic devices.

In order to execute the vulnerability checking program 200, the processor 110 may load the vulnerability checking program 200 and information required for executing the vulnerability checking program 200 from the memory 130.

The processor 110 may execute the vulnerability checking program 200 to classify electronic devices using at least two device classification methods and check the vulnerability of the classified electronic devices.

The DB unit 140 may include at least one DB necessary for the vulnerability checking device 100 to classify electronic devices and check the vulnerability of the electronic devices.

According to an embodiment, the DB unit 140 may include at least one of a MAC address DB 141, an electronic device DB 142, an analysis DB 143, a response message DB 144, a web page address DB 145, a web page code DB 146, and a vulnerability DB 147.

Here, the MAC address DB 141 may be a DB in which a MAC address for each product of the electronic device is collected, the electronic device DB 142 may be a DB in which a product name for each manufacturer of the electronic device is collected, the analysis DB 143 may be a DB in which data requiring user analysis for the classification of the electronic device is collected, the response message DB 144 may be a DB in which a response message received from the electronic device for the classification of the electronic device is collected together with a manufacturer and/or a product name of the electronic device, the web page address DB 145 may be a DB in which a web page address is collected for each manufacturer or product of the manufacturer, the web page code DB 146 may be a DB in which a web page code generated by crawling the web page of the electronic device for the classification of the electronic device is collected together with a web page address, a manufacturer, and/or a product name of the electronic device, and the vulnerability

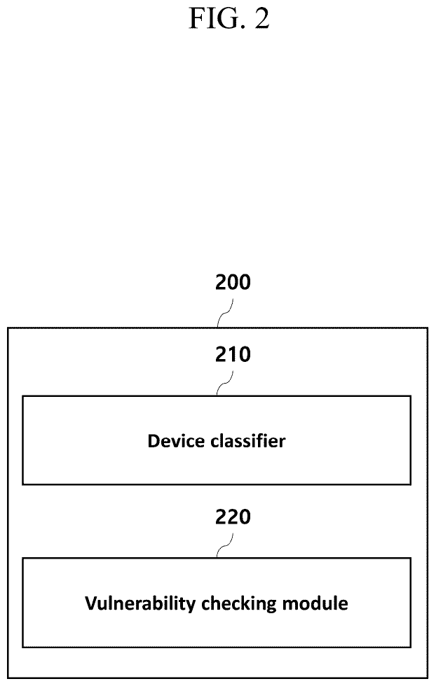

The function and/or operation of the vulnerability checking program 200 will be described in detail with reference to FIG. 2.

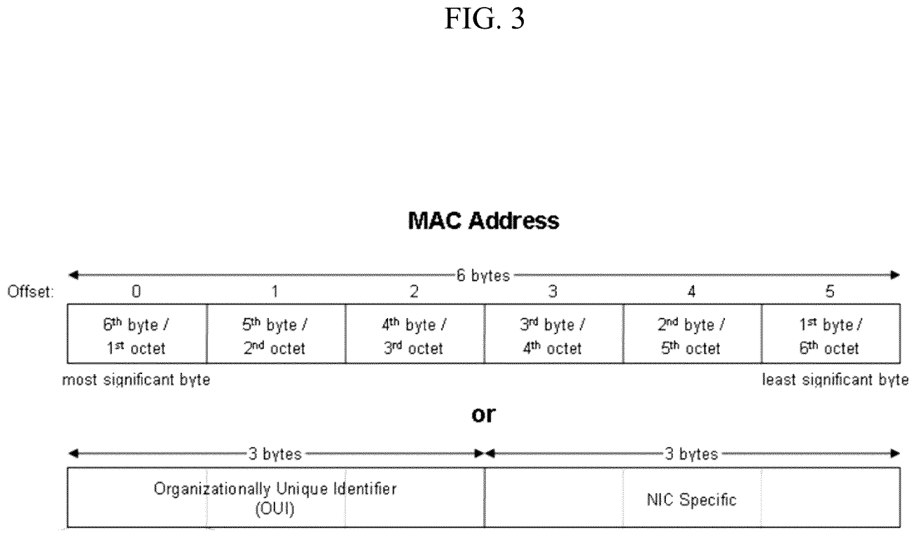

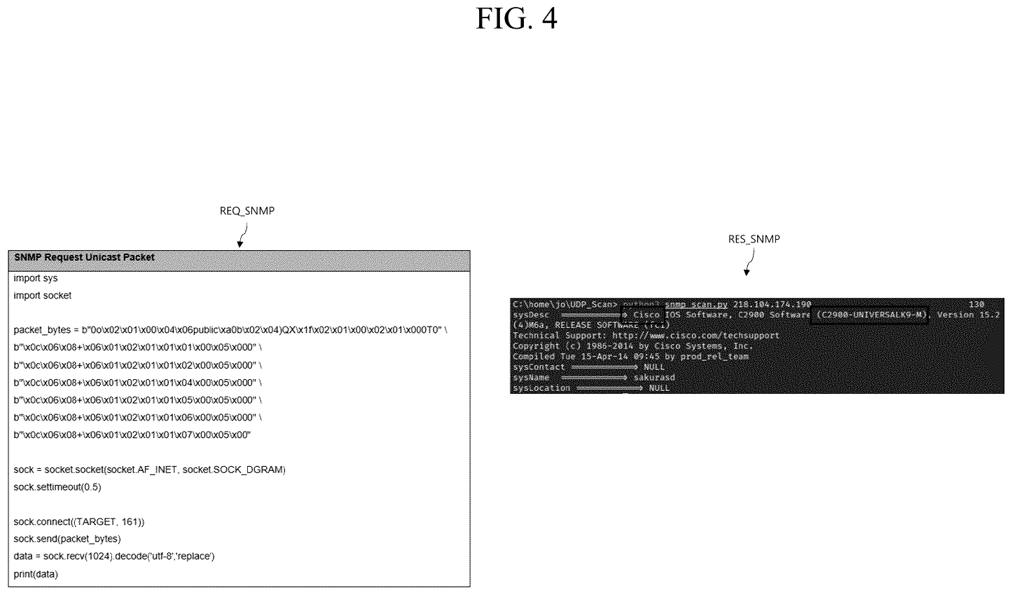

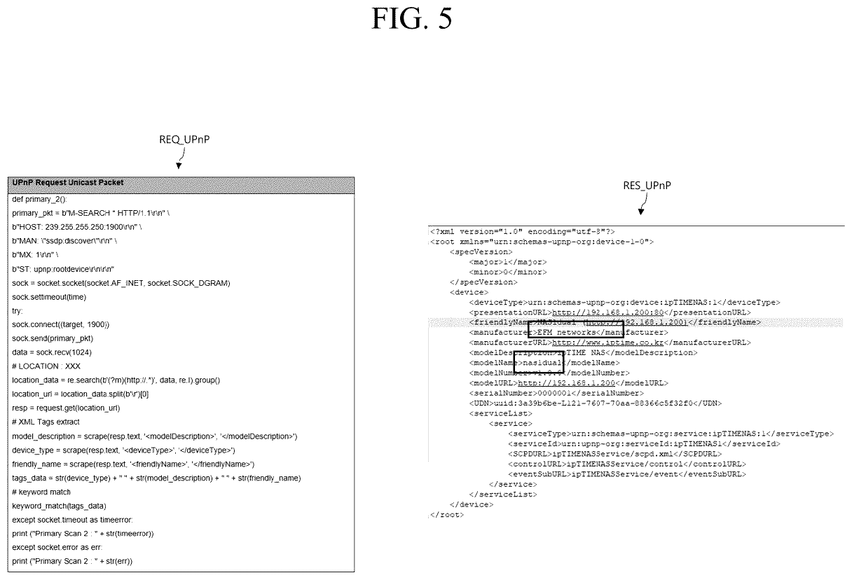

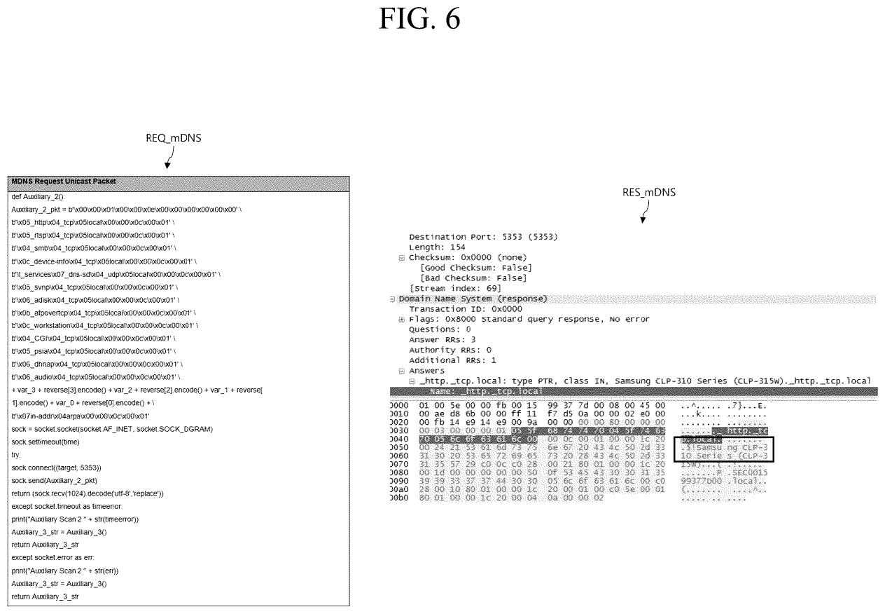

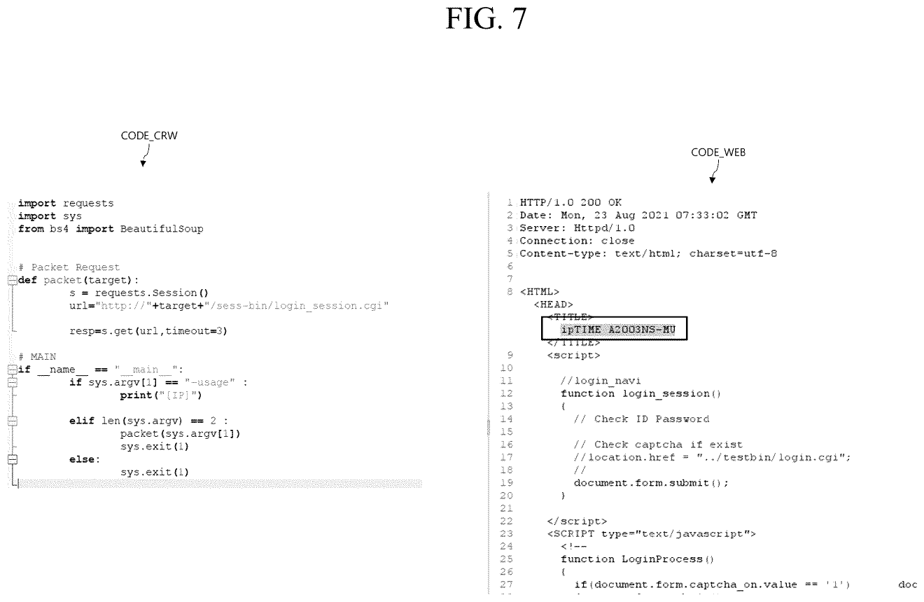

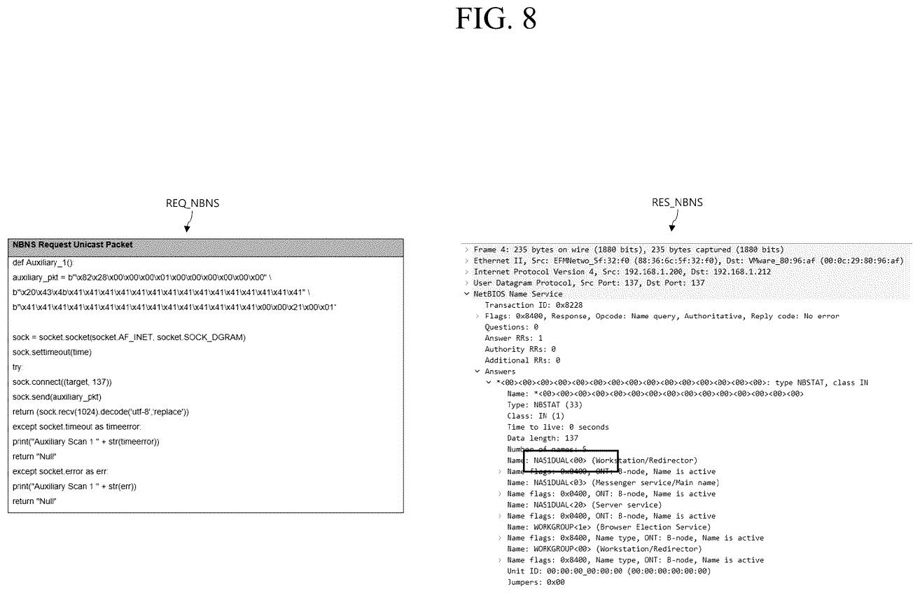

FIG. 2 is a block diagram conceptually illustrating a function of a vulnerability checking program according to an embodiment, FIG. 3 is an example of a MAC address, FIG. 4 is an example of classifying electronic devices by using a second method according to an embodiment, FIG. 5 is an example of classifying electronic devices by using a third method according to an embodiment, FIG. 6 is an example of classifying electronic devices by using a fourth method according to an embodiment, FIG. 7 is an example of classifying electronic devices by using a fifth method according to an embodiment, and FIG. 8 is an example of classifying electronic devices by using a sixth method according to an embodiment.

Referring to FIGS. 1 and 2, the vulnerability checking program 200 may include a device classifier 210 and a vulnerability checking module 220.

The device classifier 210 and the vulnerability checking module 220 illustrated in FIG. 2 conceptually divide the functions of the vulnerability checking program 200 in order to easily describe the functions of the vulnerability checking program 200, but are not limited thereto. According to embodiments, the functions of the device classifier 210 and the vulnerability checking module 220 may be merged/separated, and may be implemented as a series of instructions included in one program.

The device classifier 210 may classify electronic devices using at least two device classification methods.

In this specification, the term “classifying electronic devices” may refer to identifying a manufacturer and a product name of the electronic devices, and distinguishing the electronic devices from other products of the same manufacturer or other products of other manufacturers through the identified manufacturer and product name.

In addition, in the present specification, the product name may be a concept including not only a brand name such as “Galaxy S23” but also a serial number given by a manufacturer in order to clearly distinguish a product such as “SM-S911N”.

According to an embodiment, the device classification method may include at least one of 1) a first method of using a MAC address, 2) a second method of using a Simple Network Management Protocol (SNMP), 3) a third method of using a Universal Plug and Play (UPnP) (or a Simple Service Discovery Protocol (SSDP)), 4) a fourth method of using a Bonjour protocol, 5) a fifth method of using a web page provided by an electronic device, and 6) a sixth method of using a NetBIOS.

According to embodiments, the device classifier 210 may classify electronic devices by sequentially performing the first to sixth methods. That is, the device classifier 210 may classify the electronic devices using the first method, classify the electronic devices using the second method, classify the electronic devices using the third method, classify the electronic devices using the fourth method, classify the electronic devices using the fifth method, classify the electronic devices using the sixth method, and finally classify the electronic devices using the classified results.

Alternatively, according to an embodiment, the device classifier 210 may classify electronic devices by sequentially performing at least two of the first to sixth methods. That is, the device classifier 210 may sequentially perform at least two preconfigured methods from among the first method to the sixth method to classify the electronic devices, or may sequentially perform at least two preconfigured methods from among the first method to the sixth method, and as a result, the classification of the electronic devices is completed and thus the electronic devices may not be further performed. In this case, at least two performed from among the first to sixth methods may correspond to numbers that are not adjacent to each other. That is, although the first method, the second method, and the third method may be performed, the first method, the second method, and the fourth method may also be performed.

This is because the cost of time, resources, and the like used to classify the electronic devices in the order of the first method to the sixth method is low and the reliability is high (that is, since the MAC address used in the first method can be modulated and the virtual MAC address can be used, the reliability is lower than that of other methods). Accordingly, the vulnerability checking program 200 classifies the electronic devices by using a simple and low reliability method, and then additionally classifies the electronic devices by using a more complicated or high reliability method when additional classification for increasing the accuracy of the classification is required.

Hereinafter, a method of classifying electronic devices using each device classification method will be described in order.

### 1) First Method of Using a MAC Address

The device classifier 210 may collect MAC addresses of the electronic devices, analyze the collected MAC addresses, and classify the electronic devices.

To describe this, referring to FIG. 3, the MAC address may include a Organizationally Unique Identifier (OUI) and network interface controller (NIC) Specific information.

Here, the OUI includes information for identifying a manufacturer of the electronic device, and the NIC Specific information is a unique number allocated by the manufacturer of the electronic device and may be used to identify a product name of the electronic device.

Accordingly, the device classifier 210 may confirm the manufacturer and product name of the electronic device by confirming the MAC address of the electronic device.

According to an embodiment, the vulnerability checking device 100 may include a MAC address DB 141 in which MAC addresses for respective products are pre-collected and classified. The device classifier 210 may compare the OUI in the MAC address with the plurality of OUIs stored in the MAC address DB 141 to identify the manufacturer of the electronic device, and may compare the NIC Specific information in the MAC address with the plurality of NIC Specific information stored in the MAC address DB 141 to identify the product name of the electronic device.

That is, the device classifier 210 may determine a manufacturer corresponding to the same OUI as the OUI within the MAC address among the plurality of OUIs stored in the MAC address DB 141 as a manufacturer of the electronic device, and may determine a product name corresponding to the same NIC Specific information as the NIC Specific information within the MAC address among the plurality of NIC Specific information stored in the MAC address DB 141 as a product name of the electronic device.

On the other hand, when the OUI identical to the OUI included in the MAC address of the electronic device does not exist in the MAC address DB 141, or when the NIC Specific information identical to the NIC Specific information included in the MAC address of the electronic device does not exist, the device classifier 210 may classify the electronic device using the banner information, and update the classification result (that is, the manufacturer corresponding to the QUI included in the MAC address of the electronic device and/or the product name corresponding to the NIC Specific information included in the MAC address of the electronic device) in the MAC address DB 141.

### 2) Second Method of Using SNMP

The device classifier 210 may transmit a request message using SNMP to an electronic device, receive a response message from the electronic device in response to the transmitted request message, and classify the electronic device by analyzing the received response message.

According to an embodiment, the request message is a message for requesting information on the manufacturer and product name of the electronic device, and may include a field (or a flag, an index, etc.) for identifying the manufacturer and product name of the electronic device. For example, the request message may include sysDescr, sysObjectID, sysUpTime, sysContact, sysName, sysLocation, etc.

Accordingly, when receiving the request message from the device classifier 210, the electronic device may transmit a response message including information for identifying the manufacturer and product name of the electronic device in response to the request message.

According to an embodiment, the vulnerability checking device 100 may include an electronic device DB 142 in which product names for respective manufacturers are previously collected. The device classifier 210 may compare the plurality of manufacturers included in the electronic device DB 142 with the string included in the response message to identify the manufacturer of the electronic device, and may compare the plurality of product names of the identified manufacturer among the product names included in the electronic device DB 142 with the string included in the response message to identify the product name of the electronic device.

That is, the device classifier 210 may determine whether there is a manufacturer included in the text string in the response message among the manufacturers stored in the electronic device DB 142, and determine the corresponding manufacturer as the manufacturer of the electronic device when there is the manufacturer included in the text string. Also, the device classifier 210 may check whether there is a product name included in the text string in the response message among the plurality of product names of the manufacturer stored in the electronic device DB 142 and checked in advance, and determine the corresponding product name as the product name of the electronic device when there is the product name included in the text string.

For example, referring to FIG. 4, when the device classifier 210 transmits the request message REQ_SNMP using the SNMP to the electronic device, it may receive the response message RES_SNMP from the electronic device in response to the request message REQ_SNMP. The device classifier 210 may check that “Cisco” is included in the string in the response message RES_SNMP among the plurality of manufacturers included in the electronic device DB 142, and may determine “Cisco” included in the string in the response message RES_SNMP as the manufacturer of the electronic device. Also, the device classifier 210 may check that “C2900-UNIVERSALK9-M” is included in the string in the response message RES_SNMP among the product names of “Cisco” included in the electronic device DB 142, and may determine “C2900-UNIVERSALK9-M” included in the string in the response message RES_SNMP as the product name of the electronic device.

On the other hand, when the character string in the response message does not include the manufacturer stored in the electronic device DB 142 or the product name stored in the electronic device DB 142, the device classifier 210 may store the response message in the analysis DB 143 included in the vulnerability checking device 100.

When the user analyzes the response message stored in the analysis DB 143 and identifies the manufacturer and the product name of the electronic device having transmitted the response message, the user may input the manufacturer and the product name of the identified electronic device to the vulnerability checking device 100. When the user inputs the manufacturer and product name of the electronic device, the device classifier 210 may update the input manufacturer and product name in the electronic device DB 142.

Meanwhile, according to an embodiment, when the vulnerability checking device 100 includes the response message DB 144 for storing the response message, the device classifier 210 may store the response message of which the manufacturer and product name are identified in the response message DB 144 together with the manufacturer and product name of the electronic device that transmitted the response message. The device classifier 210 may compare the received response message with the response message stored in the response message DB 144, and when the received response message is the same as the response message stored in the response message DB 144 as a result of the comparison, may classify the electronic device that has transmitted the received response message as the same device as the electronic device that has transmitted the response message stored in the response message DB 144. Accordingly, the device classifier 210 may classify electronic devices transmitting the response message without analyzing the character string in the response message.

### 3) Third Method of Using UPnP (or SSDP)

The device classifier 210 may transmit a request message using UPnP (or SSDP) to an electronic device, receive a response message from the electronic device in response to the transmitted request message, and analyze the received response message to classify the electronic device.

According to an embodiment, the request message is a message for requesting information on the manufacturer and product name of the electronic device, and may include a field (or a flag, an index, etc.) for identifying the manufacturer and product name of the electronic device.

Accordingly, when receiving the request message from the device classifier 210, the electronic device may transmit a response message including information for identifying the manufacturer and product name of the electronic device in response to the request message.

According to an embodiment, the vulnerability checking device 100 may include an electronic device DB 142 in which product names for respective manufacturers are previously collected. The device classifier 210 may compare the plurality of manufacturers included in the electronic device DB 142 with the string included in the response message to identify the manufacturer of the electronic device, and may compare the plurality of product names of the identified manufacturer among the product names included in the electronic device DB 142 with the string included in the response message to identify the product name of the electronic device.

That is, the device classifier 210 may determine whether there is a manufacturer included in the text string in the response message among the manufacturers stored in the electronic device DB 142, and determine the corresponding manufacturer as the manufacturer of the electronic device when there is the manufacturer included in the text string. Also, the device classifier 210 may check whether there is a product name included in the text string in the response message among the plurality of product names of the manufacturer stored in the electronic device DB 142 and checked in advance, and determine the corresponding product name as the product name of the electronic device when there is the product name included in the text string.

For example, referring to FIG. 5, when the device classifier 210 transmits the request message REQ_UPnP using the UPnP to the electronic device, it may receive the response message RES_UPnP from the electronic device in response to the request message REQ_UPnP. The device classifier 210 may check that “EFM networks” is included in the string in the response message RES_UPnP among the plurality of manufacturers included in the electronic device DB 142, and may determine “EFM networks” included in the string in the response message RES_UPnP as the manufacturer of the electronic device. In addition, the device classifier 210 may check that “nasldual” is included in the string in the response message RES_UPnP among the product names of “EFM networks” included in the electronic device DB 142, and may determine “nasldual” included in the string in the response message RES_UPnP as the product name of the electronic device.

On the other hand, when the character string in the response message does not include the manufacturer stored in the electronic device DB 142 or the product name stored in the electronic device DB 142, the device classifier 210 may store the response message in the analysis DB 143 included in the vulnerability checking device 100.

When the user analyzes the response message stored in the analysis DB 143 and identifies the manufacturer and the product name of the electronic device having transmitted the response message, the user may input the manufacturer and the product name of the identified electronic device to the vulnerability checking device 100. When the user inputs the manufacturer and product name of the electronic device, the device classifier 210 may update the input manufacturer and product name in the electronic device DB 142.

Meanwhile, according to an embodiment, when the vulnerability checking device 100 includes the response message DB 144 for storing the response message, the device classifier 210 may store the response message of which the manufacturer and product name are identified in the response message DB 144 together with the manufacturer and product name of the electronic device that transmitted the response message. The device classifier 210 may compare the received response message with the response message stored in the response message DB 144, and when the received response message is the same as the response message stored in the response message DB 144 as a result of the comparison, may classify the electronic device that has transmitted the received response message as the same device as the electronic device that has transmitted the response message stored in the response message DB 144. Accordingly, the device classifier 210 may classify electronic devices transmitting the response message without analyzing the character string in the response message.

### 4) Fourth Method of Using Bonjour Protocol

The device classifier 210 may classify electronic devices using a multicast domain name system (mDNS) provided by the Bonjour protocol.

More specifically, the device classifier 210 may transmit a request message using mDNS to an electronic device, receive a response message from the electronic device in response to the transmitted request message, and analyze the received response message to classify the electronic device.

According to an embodiment, the request message is a message for requesting information on the manufacturer and product name of the electronic device, and may include a field (or a flag, an index, etc.) for identifying the manufacturer and product name of the electronic device.

Accordingly, when receiving the request message from the device classifier 210, the electronic device may transmit a response message including information for identifying the manufacturer and product name of the electronic device in response to the request message.

According to an embodiment, the vulnerability checking device 100 may include an electronic device DB 142 in which product names for respective manufacturers are previously collected. The device classifier 210 may compare the plurality of manufacturers included in the electronic device DB 142 with the string included in the response message to identify the manufacturer of the electronic device, and may compare the plurality of product names of the identified manufacturer among the product names included in the electronic device DB 142 with the string included in the response message to identify the product name of the electronic device.

That is, the device classifier 210 may determine whether there is a manufacturer included in the text string in the response message among the manufacturers stored in the electronic device DB 142, and determine the corresponding manufacturer as the manufacturer of the electronic device when there is the manufacturer included in the text string. Also, the device classifier 210 may check whether there is a product name included in the text string in the response message among the plurality of product names of the manufacturer stored in the electronic device DB 142 and checked in advance, and determine the corresponding product name as the product name of the electronic device when there is the product name included in the text string.

For example, referring to FIG. 6, when the device classifier 210 transmits the request message REQ_mDNS using the mDNS to the electronic device, it may receive the response message RES_mDNS from the electronic device in response to the request message REQ_mDNS. The device classifier 210 may check that “samsung” is included in the string in the response message RES_mDNS among the plurality of manufacturers included in the electronic device DB 142, and may determine “samsung” included in the string in the response message RES_mDNS as the manufacturer of the electronic device. In addition, the device classifier 210 may check that “CLP-315W” is included in the string in the response message RES_mDNS among the product names of “samsung” included in the electronic device DB 142, and may determine “CLP-315W” included in the string in the response message RES_mDNS as the product name of the electronic device.

On the other hand, when the character string in the response message does not include the manufacturer stored in the electronic device DB 142 or the product name stored in the electronic device DB 142, the device classifier 210 may store the response message in the analysis DB 143 included in the vulnerability checking device 100.

When the user analyzes the response message stored in the analysis DB 143 and identifies the manufacturer and the product name of the electronic device having transmitted the response message, the user may input the manufacturer and the product name of the identified electronic device to the vulnerability checking device 100. When the user inputs the manufacturer and product name of the electronic device, the device classifier 210 may update the input manufacturer and product name in the electronic device DB 142.

Meanwhile, according to an embodiment, when the vulnerability checking device 100 includes the response message DB 144 for storing the response message, the device classifier 210 may store the response message of which the manufacturer and product name are identified in the response message DB 144 together with the manufacturer and product name of the electronic device that transmitted the response message. The device classifier 210 may compare the received response message with the response message stored in the response message DB 144, and when the received response message is the same as the response message stored in the response message DB 144 as a result of the comparison, may classify the electronic device that has transmitted the received response message as the same device as the electronic device that has transmitted the response message stored in the response message DB 144. Accordingly, the device classifier 210 may classify electronic devices transmitting the response message without analyzing the character string in the response message.

### 5) Fifth Method of Using a Web Page Provided by an Electronic Device

The device classifier 210 may access a web page provided by an electronic device, crawl the accessed web page, and analyze a web page code corresponding to a result of crawling to classify the electronic device. For management of the electronic device, environment setting, etc., a web page accessible in the electronic device may be set. Accordingly, the device classifier 210 may identify the manufacturer and/or product name of the electronic device by crawling the corresponding web page.

First, the device classifier 210 may check a web page address capable of accessing a web page provided by an electronic device. To this end, according to an embodiment, the vulnerability checking device 100 may include a web page address DB 145 in which web page addresses are previously collected for each manufacturer or product of the manufacturer.

Accordingly, the device classifier 210 may input a plurality of web page addresses stored in the web page address DB 145 to the electronic device, and may determine a web page address (i.e., a web page address that does not cause a connection failure or a web page address that does not show a window indicating that there is no web page) connected to a web page among the plurality of web pages as a web page address that can be connected to a web page provided by the electronic device.

Thereafter, the device classifier 210 may obtain a web page code by crawling a web page provided by the electronic device, and classify the electronic device by analyzing the obtained web page code. To this end, according to an embodiment, the vulnerability checking device 100 may include an electronic device DB 142 in which product names for respective manufacturers have been previously collected.

Accordingly, the device classifier 210 may identify the manufacturer of the electronic device by comparing the plurality of manufacturers included in the electronic device DB 142 with the string included in the web page code, and may identify the product name of the electronic device by comparing the plurality of product names of the identified manufacturer among the product names included in the electronic device DB 142 with the string included in the web page code.

That is, the device classifier 210 may determine whether there is a manufacturer included in the text string in the web page code among the manufacturers stored in the electronic device DB 142, and determine the corresponding manufacturer as the manufacturer of the electronic device when there is the manufacturer included in the text string. Also, the device classifier 210 may check whether there is a product name included in the text string in the web page code among the plurality of product names of the manufacturer stored in the electronic device DB 142 and checked in advance, and determine the corresponding product name as the product name of the electronic device when there is the product name included in the text string.

For example, referring to FIG. 7, the device classifier 210 may input a crawling code CODE_CRW to an electronic device in order to crawl a web page provided by the electronic device, and may obtain the web page code CODE_WEB as a result of the input of the crawling code CODE_CRW. The device classifier 210 may confirm that “ipTIME” is included in the string in the web page code CODE_WEB among the plurality of manufacturers included in the electronic device DB 142, and may determine “ipTIME” included in the string in the web page code CODE_WEB as the manufacturer of the electronic device. Also, the device classifier 210 may confirm that “A2003NS-MU” is included in the string in the web page code CODE_WEB among the product names of “ipTIME” included in the electronic device DB 142, and may determine “A2003NS-MU” included in the string in the web page code CODE_WEB as the product name of the electronic device.

On the other hand, when the manufacturer stored in the electronic device DB 142 is not included or the product name stored in the electronic device DB 142 is not included in the string in the web page code, the device classifier 210 may store the web page code in the analysis DB 143 included in the vulnerability checking device 100.

When the user analyzes the web page code stored in the analysis DB 143 and identifies the manufacturer and product name of the electronic device corresponding to the web page code, the user may input the manufacturer and product name of the identified electronic device to the vulnerability checking device 100. When the user inputs the manufacturer and product name of the electronic device, the device classifier 210 may update the input manufacturer and product name in the electronic device DB 142.

Meanwhile, according to an embodiment, when the vulnerability checking device 100 includes the web page code DB 146 for storing the web page code, the device classifier 210 may store the web page code of which the manufacturer and the product name are identified in the web page code DB 146 together with the web page address and the manufacturer and the product name of the electronic device that provided the web page. The device classifier 210 may compare the crawled web page code with the web page code stored in the web page code DB 146, and may classify the electronic device of the crawled web page code as the same device as the electronic device of the web page code stored in the web page code DB 146 when the crawled web page code is identical to the web page code stored in the web page code DB 146 according to the comparison result. Accordingly, the device classifier 210 may classify electronic devices without analyzing the crawled web page code.

### 6) Sixth Method of Using NetBIOS

The device classifier 210 may classify electronic devices using a NetBIOS Name Service (NBNS) provided by NetBIOS. The NBNS is a service for registering, searching, and releasing a name of a network resource in NetBios, and the device classifier 210 may identify a product name of an electronic device by using the NBNS.

When the sixth method is used, the manufacturer of the electronic device is not acquired, and thus the device classifier 210 may perform the sixth method for product name verification when the manufacturer of the electronic device is verified through at least one of the first method and the second method but the product name is not verified.

The device classifier 210 may transmit a request message using NBNS to an electronic device, receive a response message from the electronic device in response to the transmitted request message, and classify the electronic device by analyzing the received response message.

According to an embodiment, the request message is a message for requesting information on the product name of the electronic device, and may include a field (or flag, index, etc.) for identifying the product name of the electronic device.

Accordingly, when receiving the request message from the device classifier 210, the electronic device may transmit a response message including information for identifying the product name of the electronic device in response to the request message.

According to an embodiment, the vulnerability checking device 100 may include an electronic device DB 142 in which product names for respective manufacturers are previously collected. The device classifier 210 may compare a plurality of product names of a previously identified manufacturer among the product names included in the electronic device DB 142 with the string included in the response message to identify the product name of the electronic device.

That is, the device classifier 210 may check whether there is a product name included in the text string in the response message among the plurality of product names of the manufacturer stored in the electronic device DB 142 and checked in advance, and determine the corresponding product name as the product name of the electronic device when there is the product name included in the text string.

For example, referring to FIG. 8, when the manufacturer of the electronic device is identified as “EFM networks” through at least one of the first method and the second method, and when the request message REQ_NBNS using the NBNS is transmitted to the electronic device, the device classifier 210 may receive the response message RES_NBNS from the electronic device as a response to the request message REQ_NBNS. The device classifier 210 may check that “nasldual” is included in the string in the response message RES_NBNS among the product names of “EFM networks” included in the electronic device DB 142, and may determine “nasldual” included in the string in the response message RES_NBNS as the product name of the electronic device.

On the other hand, when the product name stored in the electronic device DB 142 is not included in the text string in the response message, the device classifier 210 may store the response message in the analysis DB 143 included in the vulnerability checking device 100.

When the user analyzes the response message stored in the analysis DB 143 and identifies the product name of the electronic device that has transmitted the response message, the user may input the identified product name of the electronic device to the vulnerability checking device 100. When the user inputs the product name of the electronic device, the device classifier 210 may update the input product name in the electronic device DB 142.

Meanwhile, according to an embodiment, when the vulnerability checking device 100 includes the response message DB 144 for storing the response message, the device classifier 210 may store the response message of which the product name is identified in the response message DB 144 together with the product name of the electronic device that transmitted the response message. The device classifier 210 may compare the received response message with the response message stored in the response message DB 144, and when the received response message is the same as the response message stored in the response message DB 144 as a result of the comparison, may classify the electronic device that has transmitted the received response message as the same device as the electronic device that has transmitted the response message stored in the response message DB 144. Accordingly, the device classifier 210 may classify electronic devices transmitting the response message without analyzing the character string in the response message.

The vulnerability checking module 220 may check whether a vulnerability is present in the classified electronic device and generate a check result.

More specifically, when the manufacturer and product name of the electronic device are determined, the vulnerability checking module 220 may load information about the vulnerability of the electronic device from the vulnerability DB 147 included in the vulnerability checking device 100, and may check whether the vulnerability is present exists in the electronic device based on the loaded information about the vulnerability. According to an embodiment, the information about the vulnerability may include at least one of vulnerability information about a product name of the electronic device (e.g., common vulnerabilities and exposure (CVE) information), vulnerability information about a type of the electronic device (e.g., CVE information), and vulnerability information about a manufacturer of the electronic device (e.g., CVE information).

That is, the vulnerability checking module 220 may load the CVE for the product name, the CVE for the product type, and the CVE for the manufacturer of the electronic device from the vulnerability DB 147, and transmit a proof of concept (POC) code corresponding to the loaded CVE to the electronic device, thereby checking whether a vulnerability corresponding to the CVE actually exists in the electronic device. Here, the CVE information is information indicating a security vulnerability of a publicly known electronic device (or software), and the POC code is an attack code corresponding to a concept verification code based on the CVE information, and may be a display source code for checking whether an attack using a vulnerability corresponding to the CVE information is actually possible.

The vulnerability checking module 220 may generate, as a result of the check, whether a vulnerability is present in the electronic device and a countermeasure when the vulnerability is present.

According to an embodiment, the vulnerability checking module 220 may output a result of the vulnerability check to the electronic device.

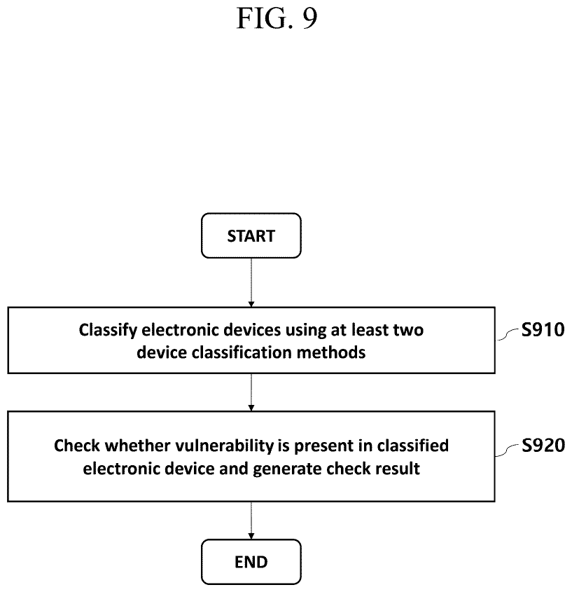

FIG. 9 is a flowchart illustrating a method of classifying an electronic device and checking a vulnerability of the electronic device by a vulnerability checking device according to an embodiment.

Referring to FIGS. 1, 2, and 9, the device classifier 210 may classify electronic devices using at least two device classification methods, step S910.

The vulnerability checking module 220 may check whether a vulnerability is present in the classified electronic device and generate a check result, step S920.

According to an embodiment of the present invention, electronic devices are classified by sequentially performing at least two of a plurality of device classification methods, thereby efficiently classifying electronic devices.

Combinations of each block of the block diagram attached to the present invention and each step of the flowchart may be performed by computer program instructions. The computer program instructions may be mounted on an encoding processor of a general purpose computer, a special purpose computer, or other programmable data processing device, and thus, the instructions performed through the encoding processor of the computer or other programmable data processing device generate means for performing functions described in each block of the block diagram or each step of the flowchart. Since these computer program instructions may be stored in a computer-usable or computer-readable memory that may direct a computer or other programmable data processing equipment to implement functions in a specific manner, the instructions stored in the computer-usable or computer-readable memory may produce manufacturing items including instruction means for performing functions described in each block of the block diagrams or each step of the flowchart diagram. Since the computer program instructions may be mounted on a computer or other programmable data processing equipment, a series of operation steps may be performed on the computer or other programmable data processing equipment to generate a process executed on the computer, and the instructions performing the computer or other programmable data processing equipment may provide steps for executing functions described in each block of the block diagram and each step of the flowchart.

Further, each block or each step may represent a part of a module, a segment, or a code including one or more executable instructions for executing the specified logical function(s). It should also be noted that in some alternative embodiments, the functions mentioned in the blocks or steps may occur out of order. For example, the two blocks or steps shown in succession may in fact be performed substantially simultaneously, or the blocks or steps may sometimes be performed in reverse order depending on the corresponding function.

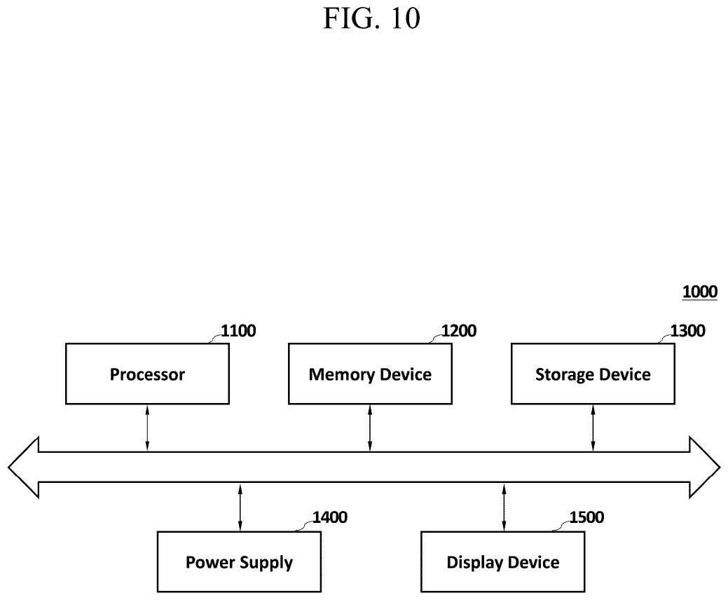

FIG. 10 is a block diagram of a computing system according to an example embodiment.

Referring to FIG. 10, a computing system 1000 may configure a vulnerability checking device 100, and may include a processor 1100, a memory device 1200, a storage device 1300, a power supply 1400, and a display device 1500. Although not illustrated in FIG. 10, the computing system 1000 may further include ports for communicating with a video card, a sound card, a memory card, a universal serial bus (USB) device, other electronic devices, etc.

As described above, the processor 1100, the memory device 1200, the storage device 1300, the power supply 1400, and the display device 1500 included in the computing system 1000 may configure the vulnerability checking device 100 according to embodiments of the inventive concept to perform a vulnerability check method. In detail, the processor 1100 may perform the vulnerability check method described with reference to FIGS. 1 to 9 by controlling the memory device 1200, the storage device 1300, the power supply 1400, and the display device 1500.

The processor 1100 may perform various computing functions. The processor 1100 may be a microprocessor or a Central Processing Unit (CPU). The processor 1100 may communicate with the memory device 1200, the storage device 1300, and the display device 1500 through a bus 1600 such as an address bus, a control bus, or a data bus. According to an embodiment, the processor 1100 may be connected to an expansion bus such as a Peripheral Component Interconnect (PCI) bus.

The memory device 1200 may store data necessary for an operation of the computing system 1000. For example, the memory device 1200 may be implemented as a DRAM, a mobile DRAM, an SRAM, a PRAM, an FRAM, an RRAM, and/or an MRAM. The storage device 1300 may include a solid state drive, a hard disk drive, a CD-ROM, etc. The storage device 1300 may store programs, application program data, system data, operating system data, and the like related to the vulnerability check methods described above with reference to FIGS. 1 to 10.

The display device 1500 is an output means for performing a notification for a user, and may notify a user or the like of information on the vulnerability check method by displaying the information on the vulnerability check method. The power supply 1400 may supply an operating voltage required for an operation of the computing system 1000.

According to an embodiment of the present invention, electronic devices are classified by sequentially performing at least two of a plurality of device classification methods, thereby efficiently classifying electronic devices.

The above description is merely illustrative of the technical spirit of the present invention, and various modifications and changes may be made by those skilled in the art without departing from the essential quality of the present invention. Therefore, the embodiments disclosed in the present disclosure are not intended to limit the technical spirit of the present disclosure, but to explain the same, and the scope of the technical spirit of the present disclosure is not limited by the embodiments. The protection scope of the present invention should be interpreted by the following claims, and all technical ideas within the scope equivalent thereto should be interpreted as being included in the scope of the present invention.

What is claimed is:

1. A method of checking a vulnerability of an electronic device, performed by a vulnerability checking device including at least one processor, the method comprising:
classifying the electronic device using at least two of a plurality of device classification methods in a preconfigured execution order; and
checking whether the vulnerability is present in the electronic device according to a result of the classifying the electronic device,
wherein the plurality of device classification methods comprises:
a first method of using a MAC address,
a second method of using a Simple Network Management Protocol (SNMP),
a third method of using a Universal Plug and Play (UPnP),
a fourth method of using a Bonjour protocol,
a fifth method of using a web page provided by the electronic device, and
a sixth method of using NetBIOS.

2. The method of claim 1, wherein the execution order is an ascending order of at least two of the first to sixth methods.

3. The method of claim 1, wherein the classifying the electronic device, when using the first method, comprises:
collecting the MAC address of the electronic device; and
identifying a manufacturer and a product name of the electronic device by comparing Organizationally Unique Identifier (OUI) and Network Interface Controller (NIC) Specific information included in the MAC address with a plurality of OUI and a plurality of NIC Specific information stored in a MAC address DB included in the vulnerability checking device.

4. The method of claim 1, wherein the classifying the electronic device, when using the second method, the third method, or the fourth method, comprises:
transmitting a request message using a protocol corresponding to a method used for classifying the electronic device among the SNMP, the UPnP, and the Bonjour protocol to the electronic device;
receiving a response message from the electronic device in response to the request message; and
identifying a manufacturer and a product name of the electronic device by comparing a character string in the response message with an electronic device DB included in the vulnerability checking device.

5. The method of claim 1, wherein the classifying the electronic device, when using the fifth method, comprises:
accessing the web page provided by the electronic device by using web page addresses stored in a web page address DB included in the vulnerability checking device;
obtaining a web page code by crawling the web page; and
identifying a manufacturer and a product name of the electronic device by comparing a character string in the web page code with an electronic device DB included in the vulnerability checking device.

6. The method of claim 1, wherein the classifying the electronic device, when using the sixth method, comprises:
transmitting a request message using a NetBIOS Name Service (NBNS) provided by the NetBIOS to the electronic device;
receiving a response message from the electronic device in response to the request message; and
identifying a product name of the electronic device by comparing a character string in the response message with an electronic device DB included in the vulnerability checking device.

7. The method of claim 6, wherein the identifying the product name of the electronic device comprises:
identifying a manufacturer of the electronic device by using at least one of the first to fifth methods; and
identifying the product name of the electronic device by comparing the character string in the response message with product names of the identified manufacturer among a plurality of product names stored in the electronic device DB.

8. The method of claim 6, further comprising:
storing the response message or a web page code in an analysis DB included in the vulnerability checking device when the character string does not include a manufacturer or the product name stored in the electronic device DB; and
updating the manufacturer and the product name of the electronic device in the electronic device DB when the electronic device is completely classified by using a specific manual classification method.

9. The method of claim 1, wherein the checking whether the vulnerability is present in the electronic device comprises:
loading information about the vulnerability of the electronic device from a vulnerability DB included in the vulnerability checking device;
checking whether the vulnerability is actually present in the electronic device by using the information about the vulnerability; and
transmitting a result of the checking to the electronic device.

10. A vulnerability checking device comprising:
a memory storing instructions for checking a vulnerability of an electronic device; and
a processor controlling the memory,
wherein the processor classifies electronic device using at least two of a plurality of device classification methods in a preconfigured execution order, and checks whether the vulnerability is present in the electronic device according to a result of the classifying the electronic device
wherein the plurality of device classification methods comprises:
a first method of using a MAC address,
a second method of using a SNMP (Simple Network Management Protocol),
a third method of using a Universal Plug and Play (UPnP),
a fourth method of using a Bonjour protocol,
a fifth method of using a web page provided by the electronic device, and
a sixth method of using NetBIOS.
